(19) United States
(12) Patent Application Publication
(10) Pub. No.: US 2022/0312311 A1
(43) Pub. Date: Sep. 29, 2022

(54) CELL SELECTION FOR IAB NODES

(71) Applicant: APPLE INC., Cupertino, CA (US)

(72) Inventors: Sarma V. Vangala, Cupertino, CA (US); Dawei Zhang, Cupertino, CA (US); Fangli Xu, Beijing (CN); Haijing Hu, Cupertino, CA (US); Murtaza A. Shikari, Cupertino, CA (US); Sethuraman Gurumoorthy, Cupertino, CA (US); Yuqin Chen, Beijing (CN); Zhibin Wu, Cupertino, CA (US)

(21) Appl. No.: 17/593,121

(22) PCT Filed: Apr. 8, 2020
(86) PCT No.: PCT/CN2020/083661

§ 371 Date: Sep. 9, 2021

(51) Int. Cl. H04W 48/20; H04W 36/00

(52) U.S. Cl. CPC H04W 48/20; H04W 36/00835

(57) ABSTRACT

Methods, systems, and devices for wireless communications are described for cell selection criteria for Integrated Access and Backhaul (IAB) nodes.

### TECHNICAL FIELD

This application relates generally to wireless communication systems, and in particular, to Integrated Access and Backhaul (IAB).

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE) (e.g., 4G) or new radio (NR) (e.g., 5G); the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as a Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, NR node (also referred to as a next generation Node B or g Node B (gNB)).

RANs use a radio access technology (RAT) to communicate between the RAN Node and UE. RANs can include global system for mobile communications (GSM), enhanced data rates for GSM evolution (EDGE) RAN (GERAN), Universal Terrestrial Radio Access Network (UTRAN), and/or E-UTRAN, which provide access to communication services through a core network. Each of the RANs operates according to a specific 3GPP RAT. For example, the GERAN implements GSM and/or EDGE RAT, the UTRAN implements universal mobile telecommunication system (UMTS) RAT or other 3GPP RAT, the E-UTRAN implements LTE RAT, and NG-RAN implements 5G RAT. In certain deployments, the E-UTRAN may also implement 5G RAT.

Frequency bands for 5G NR may be separated into two different frequency ranges. Frequency Range 1 (FR1) includes sub-6 GHz frequency bands, some of which are bands that may be used by previous standards, but may potentially be extended to cover potential new spectrum offerings from 410 MHz to 7125 MHz. Frequency Range 2 (FR2) includes frequency bands from 24.25 GHz to 52.6 GHz. Bands in the millimeter wave (mmWave) range of FR2 have shorter range but higher available bandwidth than bands in the FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an IAB architecture in accordance with one embodiment.

FIG. 2 illustrates an example IAB network in accordance with one embodiment.

FIG. 3 is a flowchart illustrating a method for an IAB node to select a cell in a wireless network in accordance with one embodiment.

FIG. 4 is a flowchart illustrating a method for an IAB node in a wireless network in accordance with one embodiment.

FIG. 5 is a flowchart illustrating a method for using an IAB donor node metric in accordance with one embodiment.

FIG. 6 is a flow chart illustrating a method in a wireless network comprising a plurality of IAB nodes in accordance with one embodiment.

FIG. 7 illustrates an example service based architecture in accordance with certain embodiments.

FIG. 8 illustrates a UE in accordance with one embodiment.

FIG. 9 illustrates a network node in accordance with one embodiment.

FIG. 10 schematically illustrates example IAB network in accordance with one embodiment.

FIG. 11 illustrates an example protocol architecture for IAB in accordance with one embodiment.

FIG. 12 illustrates an IAB architecture in accordance with one embodiment.

FIG. 13 illustrates an NG-RAN architecture in accordance with one embodiment.

### DETAILED DESCRIPTION

The present disclosure is related to Integrated Access and Backhaul (IAB), which is a feature being designed in 3GPP to enable multi-hop routing. IAB nodes serve as both access nodes to UEs and provide backhaul links to other IAB nodes.

Efforts are underway to identify and evaluate potential solutions for efficient operation of integrated access and wireless backhaul for NR. In certain architectures for cellular networks, NR links themselves can be used as backhaul in lieu of fiber (which often has a long lead time due to economics and logistics (e.g., long lead times for installations, inaccessibility of certain areas etc., with the heavy cost). The high bandwidth of NR links combined with the efficient split of control and data units of gNBs allows for such architectural deployments. Combined with mmWave technologies, IAB technology may be able to provide better coverage and higher throughputs to UEs that were earlier unable to get Line Of Sight coverage. The new architecture, however, now leads to the introduction of a multi-hop network that poses new challenges.

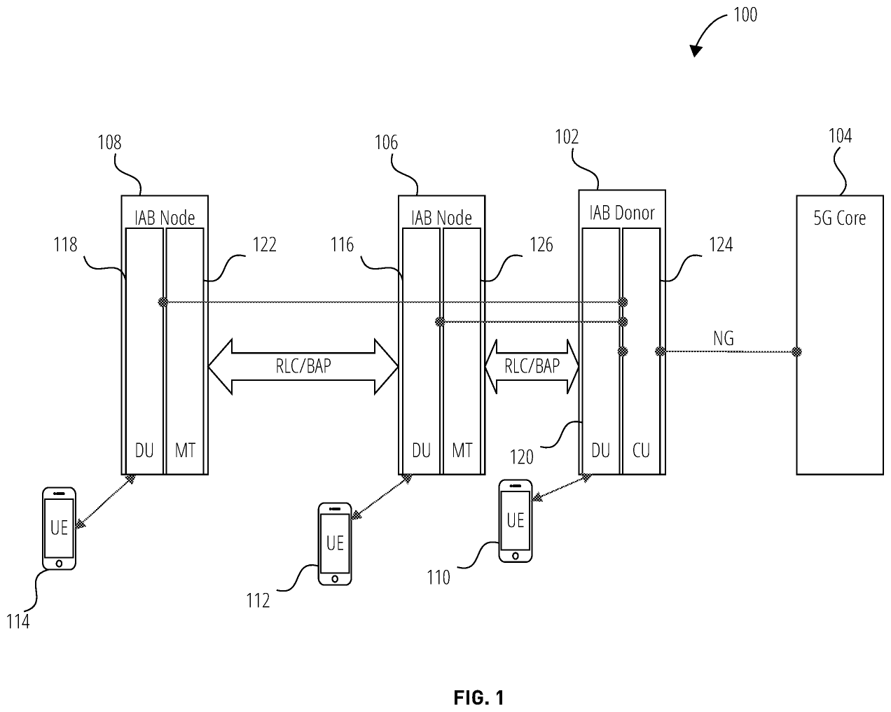

FIG. 1 illustrates an example IAB architecture 100. The IAB architecture 100 includes an IAB donor 102 with fiber connectivity (e.g., through an NG interface) with a 5G core 104, an IAB node 106, and an IAB node 108. The IAB donor 102, which may also be referred to as a backend node or a parent IAB node, comprises a data unit (DU) (shown as DU 120) and a control unit (CU) (shown as CU 124). The IAB node 106 and the IAB node 108 may be referred to as intermediate nodes and each include two sub-components: a DU (shown as DU 116 and DU 118) and a mobile terminal (MT) (shown as MT 126 and MT 122).

An MT comprises components that configure a gNB to behave similar to a regular UE. For example, protocols that typical UEs use to connect to the network are supported in the MT with additional enhancements being discussed in 3GPP Rel. 16 and Rel.17. The MT 126, for example, allows the IAB node 106 to establish signaling radio bearers (SRBs) and/or data radio bearers (DRBs) with it's parent node (the IAB donor 102). An MT performs cell selection to identify which parent to join, sets up and utilizes radio link control (RLC) through a backhaul adaptation protocol (BAP) layer that provides functionality for routing data for different UE bearers over different routes through the network.

In current wireless systems, system information block-1 (SIB1) includes information relevant when evaluating whether a UE is allowed to access a cell and defines the scheduling of other system information. SIB1 also includes radio resource configuration information that is common for all UEs and barring information applied to the unified access control. In certain such systems, the only way that a particular IAB node can access another IAB node or a donor/parent is using the criteria defined in the SIB 1. However, since IAB nodes are higher power gNBs (as compared to power of UEs), the criteria (e.g., reference signal received power (RSRP) and reference signal received quality (RSRQ) thresholds) may lead to finding multiple parents. This may lead to problems at both the IAB nodes (i.e., IAB donor 102, IAB node 106, IAB node 108) and the corresponding UEs (i.e., UE 110, UE 112, UE 114) that are connected to them.

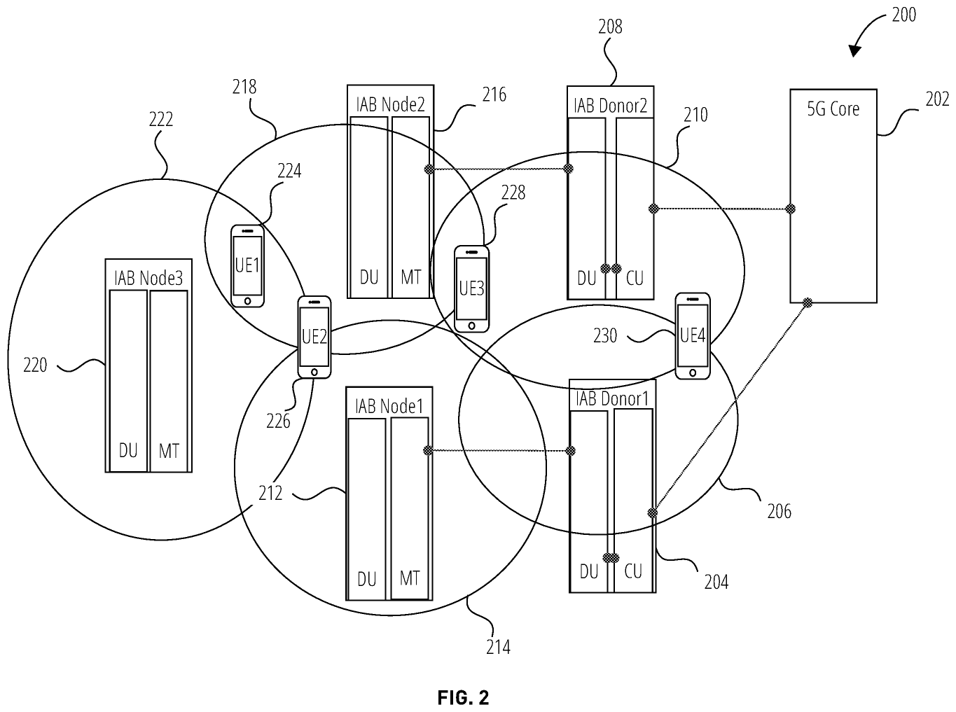

FIG. 2 illustrates an example IAB network 200 including a 5G core 202 connected through fiber to a first IAB donor 204 (IAB Donor1) with a coverage area 206 and a second IAB donor 208 (IAB Doner2) with a coverage area 210. FIG. 2 also shows a first IAB node 212 (IAB Node1) with a coverage area 214, a second IAB node 216 (IAB Node2) with a coverage area 218, a third IAB node 220 (IAB Node3) with a coverage area 222, a first UE 224 (UE1), a second UE 226 (UE2), a third UE 228 (UE3), and a fourth UE 230 (UE4). In the example shown in FIG. 2, each of the UEs and the IAB nodes are in different radio frequency (RF) conditions of next hop IAB nodes and donors leading to a potential for multiple cases where cell selection criteria for both the IAB nodes and the UEs under the coverage of those nodes can be modified.

For example, the third IAB node 220 may choose to join the first IAB node 212 or the second IAB node 216 based on cellular network loads (e.g., number of Idle and Connected UEs on the particular IAB node, number of signaling and data bearers already active on the particular IAB node or the ability to maintain QoS for a particular application service) of those particular intermediaries. Similarly, the second IAB node 216 and first IAB node 212 may join either of first IAB donor 204 and second IAB donor 208 not just purely based on S-Cell criteria, but also based on the control. The CUs in the first IAB donor 204 and the second IAB donor 208 can control this selection/connection process and help set up the end to end links.

In the illustrated example, the first UE 224, second UE 226, and third UE 228 also have multiple options. For example, the third UE 228 may to connect to a donor (i.e., first IAB donor 204 or second IAB donor 208) instead of the second IAB node 216 for latency purposes. The second UE 226 may choose to connect to the second IAB node 216 over the first IAB node 212 for load reasons between an IAB donor and an IAB node. The first UE 224 may choose third IAB node 220 instead of the second IAB node 216 based on network load. Further, the fourth UE 230 may choose the first IAB donor 204 or the second IAB donor 208 based on whichever device passes its S-criteria or reselect to cells based on its configured measurement reports. However, none of these variations are available for either the UEs or the IAB nodes today.

The strongest cell criteria that is generally used today may be easily met by multiple parent IAB nodes in a typical deployment scenario due to better hardware and power capabilities of the gNBs, as compared to those of UEs.

Thus, in one embodiment disclosed herein, two different sets of cell selection criteria are communicated in SIB1 for IAB nodes and UEs. For example, the selection criteria may include a Qrxlevmin value for UEs and a rxlevmin_iab_Node value for IAB nodes, a Qrxlevminoffset value for UEs and a Qrxlevminoffset_iab_Node value for IAB nodes, a PMax value for UEs and a PMax_iab_Node value for IAB nodes, a Qqualmin value for UEs and a Qqualmin_iab_Node value for IAB nodes, and a Qqualminoffset value for UEs and a Qqualminoffset_iab_Node value for IAB nodes. The IAB Node should be able to compute its Qqualmeas to identify a node which is not as highly loaded to be able to select to/reselect to.

The cell selection criterion S in normal coverage is fulfilled when Srxlev>0 and Squal>0, where for UEs:

Srxlev=Qrxlevmeas−(Qrxlevmin+Qrxlevminoffset)−Pcompensation−Qoffsettemp;

and

Squal=Qqualmeas−(Qqualmin+Qqualminoffset)−Qoffsettemp.

Srxlev is the cell selection receive (RX) level value (in dB). Squal is the selection quality value (in dB). Qoffsettemp is an offset temporarily applied to a cell. Qrxlevmeas is the measured cell RX level value (RSRP). Qqualmeas is the measured cell quality value (RSRQ). Qrxlevmin the minimum required RX level in the cell (in dBm). Qqualmin is the minimum required quality level in the cell (in dB). Qrxlevminoffset is an offset to the signaled Qrxlevmin taken into account in the Srxlev evaluation as a result of a periodic search for a higher priority PLMN while camped normally in a VPLMN. Qqualminoffset is an offset to the signaled Qqualmin taken into account in the Squal evaluation as a result of a periodic search for a higher priority PLMN while camped normally in a VPLMN. Pcompensation is a compensation parameter based on various power parameters including PMax, which associated with a maximum transmit (TX) power.

When performing cell selection for IABs, the equations with the corresponding set of cell selection criteria become:

Srxlev=Qrxlevmeas−(Qrxlevmin_iab_Node+Qrxlevminoffset_iab_Node)−Pcompensation−Qoffsettemp; and

Squal=Qqualmeas−(Qqualmin_iab_Node+Qqualminoffset_iab_Node)−Qoffsettemp.

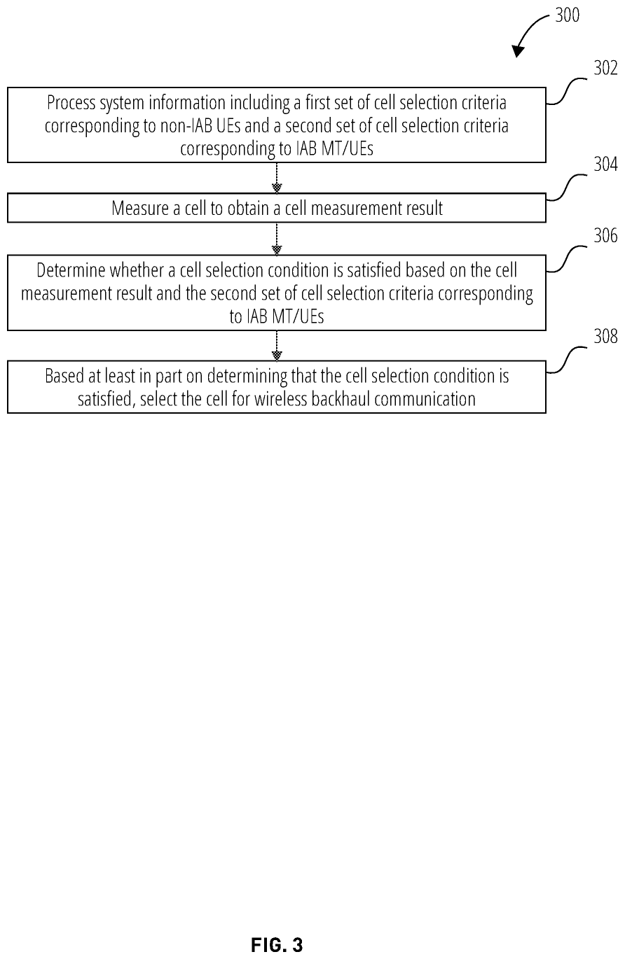

FIG. 3 is a flowchart illustrating a method 300 for an IAB node to select a cell in a wireless network according to one embodiment. In block 302, the method 300 includes processing includes processing system information including a first set of cell selection criteria corresponding to non-IAB UEs and a second set of cell selection criteria corresponding to IAB MT/UEs. In block 304, the method 300 includes measuring a cell to obtain a cell measurement result. In block 306, the method 300 includes determining whether a cell selection condition is satisfied based on the cell measurement result and the second set of cell selection criteria corresponding to IAB MT/UEs. In block 308, based at least in part on determining that the cell selection condition is satisfied, the method 300 includes selecting the cell for wireless backhaul communication.

In another embodiment, the IAB nodes are configured to broadcast its “depth” in the tree (i.e., how many hops from the node to the initial donor node). This parameter could be utilized in the selection criteria when attaching to a cell. Fewer hops may be better for an end-to-end (E2E) system when this parameter is looked at independently of the channel conditions. Additionally, the depth can be indicated as a 3-D matrix of hops, idle load, and connected load.

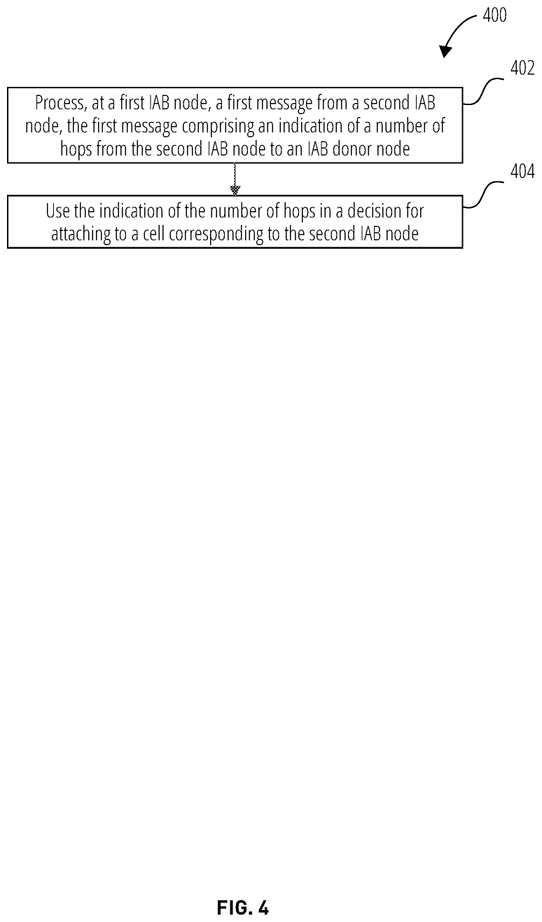

For example, FIG. 4 is a flowchart illustrating a method 400 for a first IAB node in a wireless network according to one embodiment. In block 402, the method 400 includes processing, at the first IAB node, a first message from a second IAB node. The first message comprises an indication of a number of hops from the second IAB node to an IAB donor node. In block 404, the method 400 includes using the indication of the number of hops in a decision for attaching to a cell corresponding to the second IAB node.

In another embodiment, a separate IAB donor node priority metric is used to help identify and/or prioritize an IAB donor node during node selection or reselection. The priority may, for example, be broadcast or overwritten with individual priority using dedicated signaling. For the broadcast priority option, a new information element (IE) in the SIB may be created. The IAB donor node priority metric may be based on current loads of respective IAB donor nodes.

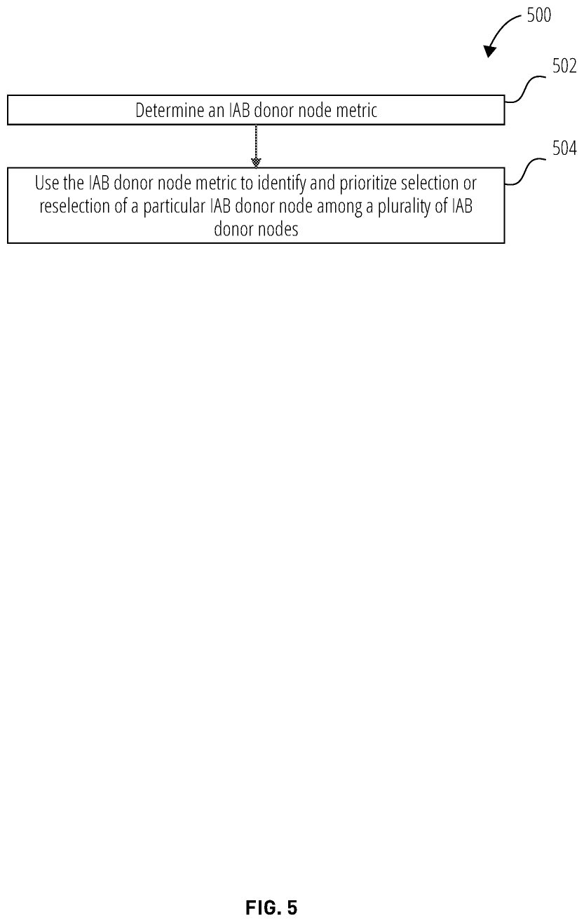

For example, FIG. 5 is a flowchart illustrating a method 500 for using an IAB donor node metric according to one embodiment. In block 502, the method 500 includes determining an IAB donor node metric. In block 504, the method 500 includes using the IAB donor node metric to identify and prioritize selection or reselection of a particular IAB donor node among a plurality of IAB donor nodes.

In another embodiment, for a faster re-selection of the IAB nodes, the IAB nodes are configured to remain in an RRC Connected Inactive state rather than go to an RRC Idle state. For example, the IAB nodes may be configured to do a re-direction always but not a re-selection.

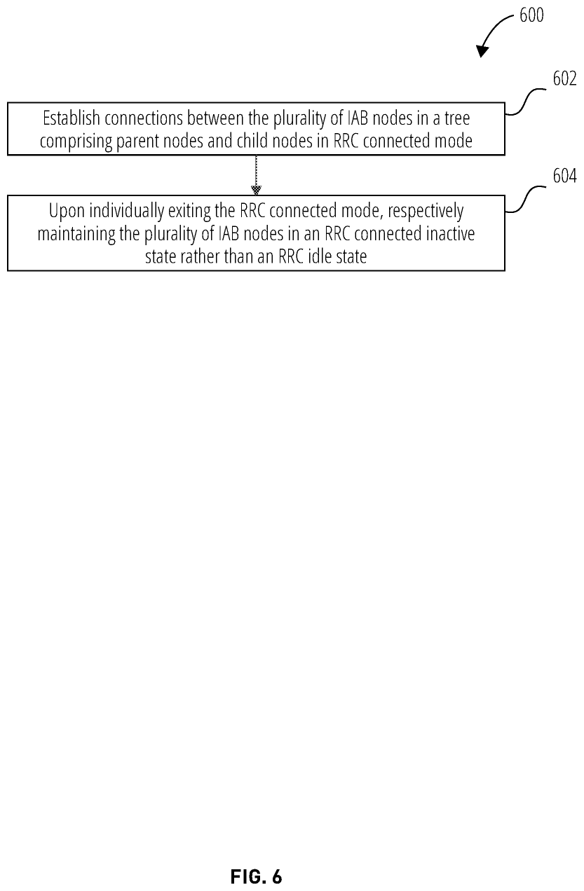

For example, FIG. 6 is a flow chart illustrating a method 600 in a wireless network comprising a plurality of IAB nodes according to one embodiment. In block 602, the method 600 includes establishing connections between the plurality of IAB nodes in a tree comprising parent nodes and child nodes in RRC connected mode. In block 604, upon individually exiting the RRC connected mode, the method 600 includes respectively maintaining the plurality of IAB nodes in an RRC connected inactive state rather than an RRC idle state.

Example System Architecture

In certain embodiments, 5G System architecture supports data connectivity and services enabling deployments to use techniques such as Network Function Virtualization and Software Defined Networking. The 5G System architecture may leverage service-based interactions between Control Plane Network Functions. Separating User Plane functions from the Control Plane functions allows independent scalability, evolution, and flexible deployments (e.g., centralized location or distributed (remote) location). Modularized function design allows for function re-use and may enable flexible and efficient network slicing. A Network Function and its Network Function Services may interact with another NF and its Network Function Services directly or indirectly via a Service Communication Proxy. Another intermediate function may help route Control Plane messages. The architecture minimizes dependencies between the AN and the CN. The architecture may include a converged core network with a common AN-CN interface that integrates different Access Types (e.g., 3GPP access and non-3GPP access). The architecture may also support a unified authentication framework, stateless NFs where the compute resource is decoupled from the storage resource, capability exposure, concurrent access to local and centralized services (to support low latency services and access to local data networks, User Plane functions can be deployed close to the AN), and/or roaming with both Home routed traffic as well as Local breakout traffic in the visited PLMN.

The 5G architecture may be defined as service-based and the interaction between network functions may include a service-based representation, where network functions (e.g., AMF) within the Control Plane enable other authorized network functions to access their services. The service-based representation may also include point-to-point reference points. A reference point representation may also be used to show the interactions between the NF services in the network functions described by point-to-point reference point (e.g., N11) between any two network functions (e.g., AMF and SMF).

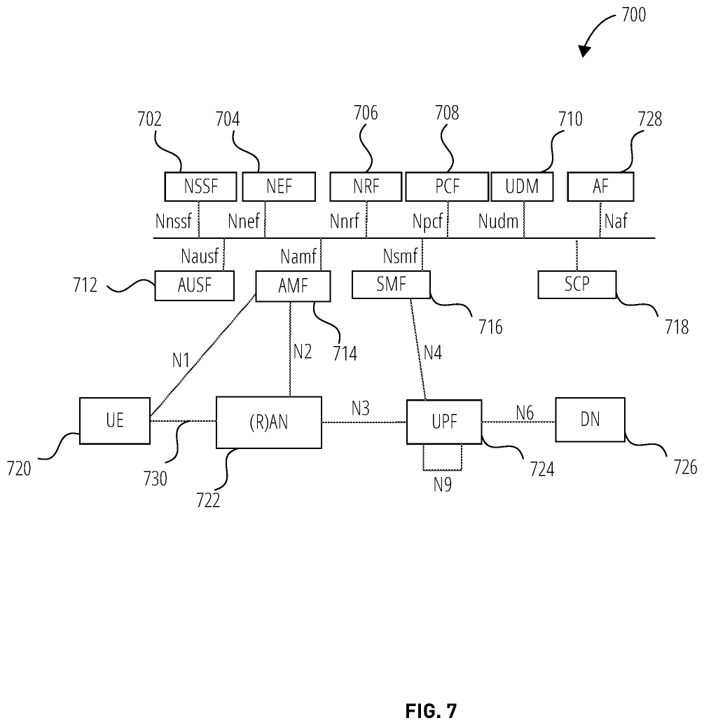

FIG. 7 illustrates a service based architecture 700 in 5GS according to one embodiment. As described in 3GPP TS 23.501, the service based architecture 700 comprises NFs such as an NSSF 702, a NEF 704, an NRF 706, a PCF 708, a UDM 710, an AUSF 712, an AMF 714, an SMF 716, for communication with a UE 720, a (R)AN 722, a UPF 724, and a DN 726. The NFs and NF services can communicate directly, referred to as Direct Communication, or indirectly via a SCP 718, referred to as Indirect Communication. FIG. 7 also shows corresponding service-based interfaces including Nutm, Naf, Nudm, Npcf, Nsmf, Nnrf, Namf, Nnef, Nnssf, and Nausf, as well as reference points N1, N2, N3, N4, and N6. A few example functions provided by the NFs shown in FIG. 7 are described below.

The NSSF 702 supports functionality such as: selecting the set of Network Slice instances serving the UE; determining the Allowed NSSAI and, if needed, mapping to the Subscribed S-NSSAIs; determining the Configured NSSAI and, if needed, the mapping to the Subscribed S-NSSAIs; and/or determining the AMF Set to be used to serve the UE, or, based on configuration, a list of candidate AMF(s), possibly by querying the NRF.

The NEF 704 supports exposure of capabilities and events. NF capabilities and events may be securely exposed by the NEF 704 (e.g., for 3rd party, Application Functions, and/or Edge Computing). The NEF 704 may store/retrieve information as structured data using a standardized interface (Nudr) to a UDR. The NEF 704 may also secure provision of information from an external application to 3GPP network and may provide for the Application Functions to securely provide information to the 3GPP network (e.g., expected UE behavior, 5GLAN group information, and service specific information), wherein the NEF 704 may authenticate and authorize and assist in throttling the Application Functions. The NEF 704 may provide translation of internal-external information by translating between information exchanged with the AF and information exchanged with the internal network function. For example, the NEF 704 translates between an AF-Service-Identifier and internal 5G Core information such as DNN and S-NSSAI. The NEF 704 may handle masking of network and user sensitive information to external AF's according to the network policy. The NEF 704 may receive information from other network functions (based on exposed capabilities of other network functions), and stores the received information as structured data using a standardized interface to a UDR. The stored information can be accessed and re-exposed by the NEF 704 to other network functions and Application Functions, and used for other purposes such as analytics. For external exposure of services related to specific UE(s), the NEF 704 may reside in the HPLMN. Depending on operator agreements, the NEF 704 in the HPLMN may have interface(s) with NF(s) in the VPLMN. When a UE is capable of switching between EPC and 5GC, an SCEF+NEF may be used for service exposure.

The NRF 706 supports service discovery function by receiving an NF Discovery Request from an NF instance or SCP and providing the information of the discovered NF instances to the NF instance or SCP. The NRF 706 may also support P-CSCF discovery (specialized case of AF discovery by SMF), maintains the NF profile of available NF instances and their supported services, and/or notify about newly registered/updated/ deregistered NF instances along with its NF services to the subscribed NF service consumer or SCP. In the context of Network Slicing, based on network implementation, multiple NRFs can be deployed at different levels such as a PLMN level (the NRF is configured with information for the whole PLMN), a shared-slice level (the NRF is configured with information belonging to a set of Network Slices), and/or a slice-specific level (the NRF is configured with information belonging to an S-NSSAI). In the context of roaming, multiple NRFs may be deployed in the different networks, wherein the NRF(s) in the Visited PLMN (known as the vNRF) are configured with information for the visited PLMN, and wherein the NRF(s) in the Home PLMN (known as the hNRF) are configured with information for the home PLMN, referenced by the vNRF via an N27 interface.

The PCF 708 supports a unified policy framework to govern network behavior. The PCF 708 provides policy rules to Control Plane function(s) to enforce them. The PCF 708 accesses subscription information relevant for policy decisions in a Unified Data Repository (UDR). The PCF 708 may access the UDR located in the same PLMN as the PCF.

The UDM 710 supports generation of 3GPP AKA Authentication Credentials, User Identification Handling (e.g., storage and management of SUPI for each subscriber in the 5G system), de-concealment of a privacy-protected subscription identifier (SUCI), access authorization based on subscription data (e.g., roaming restrictions), UE's Serving NF Registration Management (e.g., storing serving AMF for UE, storing serving SMF for UE's PDU Session), service/session continuity (e.g., by keeping SMF/DNN assignment of ongoing sessions., MT-SMS delivery, Lawful Intercept Functionality (especially in outbound roaming cases where a UDM is the only point of contact for LI), subscription management, SMS management, 5GLAN group management handling, and/or external parameter provisioning (Expected UE Behavior parameters or Network Configuration parameters). To provide such functionality, the UDM 710 uses subscription data (including authentication data) that may be stored in a UDR, in which case a UDM implements the application logic and may not require an internal user data storage and several different UDMs may serve the same user in different transactions. The UDM 710 may be located in the HPLMN of the subscribers it serves, and may access the information of the UDR located in the same PLMN.

The AF 728 interacts with the Core Network to provide services that, for example, support the following: application influence on traffic routing; accessing the NEF 704; interacting with the Policy framework for policy control; and/or IMS interactions with 5GC. Based on operator deployment, Application Functions considered to be trusted by the operator can be allowed to interact directly with relevant Network Functions. Application Functions not allowed by the operator to access directly the Network Functions may use the external exposure framework via the NEF 704 to interact with relevant Network Functions.

The AUSF 712 supports authentication for 3GPP access and untrusted non-3GPP access. The AUSF 712 may also provide support for Network Slice-Specific Authentication and Authorization.

The AMF 714 supports termination of RAN CP interface (N2), termination of NAS (N1) for NAS ciphering and integrity protection, registration management, connection management, reachability management, Mobility Management, lawful intercept (for AMF events and interface to LI System), transport for SM messages between UE and SMF, transparent proxy for routing SM messages, Access Authentication, Access Authorization, transport for SMS messages between UE and SMSF, SEAF, Location Services management for regulatory services, transport for Location Services messages between UE and LMF as well as between RAN and LMF, EPS Bearer ID allocation for interworking with EPS, UE mobility event notification, Control Plane CIoT 5GS Optimization, User Plane CIoT 5GS Optimization, provisioning of external parameters (Expected UE Behavior parameters or Network Configuration parameters), and/or Network Slice-Specific Authentication and Authorization. Some or all of the AMF functionalities may be supported in a single instance of the AMF 714. Regardless of the number of Network functions, in certain embodiments there is only one NAS interface instance per access network between the UE and the CN, terminated at one of the Network functions that implements at least NAS security and Mobility Management. The AMF 714 may also include policy related functionalities.

In addition to the functionalities described above, the AMF 714 may include the following functionality to support non-3GPP access networks: support of N2 interface with N3IWF/TNGF, over which some information (e.g., 3GPP Cell Identification) and procedures (e.g., Handover related) defined over 3GPP access may not apply, and non-3GPP access specific information may be applied that do not apply to 3GPP accesses; support of NAS signaling with a UE over N3IWF/TNGF, wherein some procedures supported by NAS signaling over 3GPP access may be not applicable to untrusted non-3GPP (e.g., Paging) access; support of authentication of UEs connected over N3IWF/TNGF; management of mobility, authentication, and separate security context state(s) of a UE connected via a non-3GPP access or connected via a 3GPP access and a non-3GPP access simultaneously; support a coordinated RM management context valid over a 3GPP access and a Non 3GPP access; and/or support dedicated CM management contexts for the UE for connectivity over non-3GPP access. Not all of the above functionalities may be required to be supported in an instance of a Network Slice.

The SMF 716 supports Session Management (e.g., Session Establishment, modify and release, including tunnel maintain between UPF and AN node), UE IP address allocation & management (including optional Authorization) wherein the UE IP address may be received from a UPF or from an external data network, DHCPv4 (server and client) and DHCPv6 (server and client) functions, functionality to respond to Address Resolution Protocol requests and/or IPv6 Neighbor Solicitation requests based on local cache information for the Ethernet PDUs (e.g., the SMF responds to the ARP and/or the IPv6 Neighbor Solicitation Request by providing the MAC address corresponding to the IP address sent in the request), selection and control of User Plane functions including controlling the UPF to proxy ARP or IPv6 Neighbor Discovery or to forward all ARP/IPv6 Neighbor Solicitation traffic to the SMF for Ethernet PDU Sessions, traffic steering configuration at the UPF to route traffic to proper destinations, 5G VN group management (e.g., maintain the topology of the involved PSA UPFs, establish and release the N19 tunnels between PSA UPFs, configure traffic forwarding at UPF to apply local switching, and/or N6-based forwarding or N19-based forwarding), termination of interfaces towards Policy control functions, lawful intercept (for SM events and interface to LI System), charging data collection and support of charging interfaces, control and coordination of charging data collection at the UPF, termination of SM parts of NAS messages, Downlink Data Notification, Initiator of AN specific SM information sent via AMF over N2 to AN, determination of SSC mode of a session, Control Plane CIoT 5GS Optimization, header compression, acting as I-SMF in deployments where I-SMF can be inserted/removed/relocated, provisioning of external parameters (Expected UE Behavior parameters or Network Configuration parameters), P-CSCF discovery for IMS services, roaming functionality (e.g., handle local enforcement to apply QoS SLAs (VPLMN), charging data collection and charging interface (VPLMN), and/or lawful intercept (in VPLMN for SM events and interface to LI System), interaction with external DN for transport of signaling for PDU Session authentication/authorization by external DN, and/or instructing UPF and NG-RAN to perform redundant transmission on N3/N9 interfaces. Some or all of the SMF functionalities may be supported in a single instance of a SMF. However, in certain embodiments, not all of the functionalities are required to be supported in an instance of a Network Slice. In addition to the functionalities , the SMF 716 may include policy related functionalities.

The SCP 718 includes one or more of the following functionalities: Indirect Communication; Delegated Discovery; message forwarding and routing to destination NF/NF services; communication security (e.g., authorization of the NF Service Consumer to access the NF Service Producer's API), load balancing, monitoring, overload control, etc.; and/or optionally interact with the UDR, to resolve the UDM Group ID/UDR Group ID/AUSF Group ID/PCF Group ID/CHF Group ID/HSS Group ID based on UE identity (e.g., SUPI or IMPI/IMPU). Some or all of the SCP functionalities may be supported in a single instance of an SCP. In certain embodiments, the SCP 718 may be deployed in a distributed manner and/or more than one SCP can be present in the communication path between NF Services. SCPs can be deployed at PLMN level, shared-slice level, and slice-specific level. It may be left to operator deployment to ensure that SCPs can communicate with relevant NRFs.

The UE 720 may include a device with radio communication capabilities. For example, the UE 720 may comprise a smartphone (e.g., handheld touchscreen mobile computing devices connectable to one or more cellular networks). The UE 720 may also comprise any mobile or non-mobile computing device, such as Personal Data Assistants (PDAs), pagers, laptop computers, desktop computers, wireless handsets, or any computing device including a wireless communications interface. A UE may also be referred to as a client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. The UE 720 may comprise an IoT UE, which can comprise a network access layer designed for low-power IoT applications utilizing short-lived UE connections. An IoT UE can utilize technologies (e.g., M2M, MTC, or mMTC technology) for exchanging data with an MTC server or device via a PLMN, other UEs using ProSe or D2D communications, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure). The IoT UEs may execute background applications (e.g., keep-alive messages, status updates, etc.) to facilitate the connections of the IoT network.

The UE 720 may be configured to connect or communicatively couple with the (R)AN 722 through a radio interface 730, which may be a physical communication interface or layer configured to operate with cellular communication protocols such as a GSM protocol, a CDMA network protocol, a Push-to-Talk (PTT) protocol, a PTT over Cellular (POC) protocol, a UMTS protocol, a 3GPP LTE protocol, a 5G protocol, a NR protocol, and the like. For example, the UE 720 and the (R)AN 722 may use a Uu interface (e.g., an LTE-Uu interface) to exchange control plane data via a protocol stack comprising a PHY layer, a MAC layer, an RLC layer, a PDCP layer, and an RRC layer. A DL transmission may be from the (R)AN 722 to the UE 720 and a UL transmission may be from the UE 720 to the (R)AN 722. The UE 720 may further use a sidelink to communicate directly with another UE (not shown) for D2D, P2P, and/or ProSe communication. For example, a ProSe interface may comprise one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The (R)AN 722 can include one or more access nodes, which may be referred to as base stations (BSs), NodeBs, evolved NodeBs (eNBs), next Generation NodeBs (gNB), RAN nodes, controllers, transmission reception points (TRPs), and so forth, and can comprise ground stations (e.g., terrestrial access points) or satellite stations providing coverage within a geographic area (e.g., a cell). The (R)AN 722 may include one or more RAN nodes for providing macrocells, picocells, femtocells, or other types of cells. A macrocell may cover a relatively large geographic area (e.g., several kilometers in radius) and may allow unrestricted access by UEs with service subscription. A picocell may cover a relatively small geographic area and may allow unrestricted access by UEs with service subscription. A femtocell may cover a relatively small geographic area (e.g., a home) and may allow restricted access by UEs having an association with the femtocell (e.g., UEs in a Closed Subscriber Group (CSG), UEs for users in the home, etc.).

Although not shown, multiple RAN nodes (such as the (R)AN 722) may be used, wherein an Xn interface is defined between two or more nodes. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for the UE 720 in a connected mode (e.g., CM-CONNECTED) including functionality to manage the UE mobility for connected mode between one or more (R)AN nodes. The mobility support may include context transfer from an old (source) serving (R)AN node to new (target) serving (R)AN node; and control of user plane tunnels between old (source) serving (R)AN node to new (target) serving (R)AN node.

The UPF 724 may act as an anchor point for intra-RAT and inter-RAT mobility, an external PDU session point of interconnect to the DN 726, and a branching point to support multi-homed PDU session. The UPF 724 may also perform packet routing and forwarding, packet inspection, enforce user plane part of policy rules, lawfully intercept packets (UP collection); traffic usage reporting, perform QoS handling for user plane (e.g. packet filtering, gating, UL/DL rate enforcement), perform Uplink Traffic verification (e.g., SDF to QoS flow mapping), transport level packet marking in the uplink and downlink, and downlink packet buffering and downlink data notification triggering. The UPF 724 may include an uplink classifier to support routing traffic flows to a data network. The DN 726 may represent various network operator services, Internet access, or third party services. The DN 726 may include, for example, an application server.

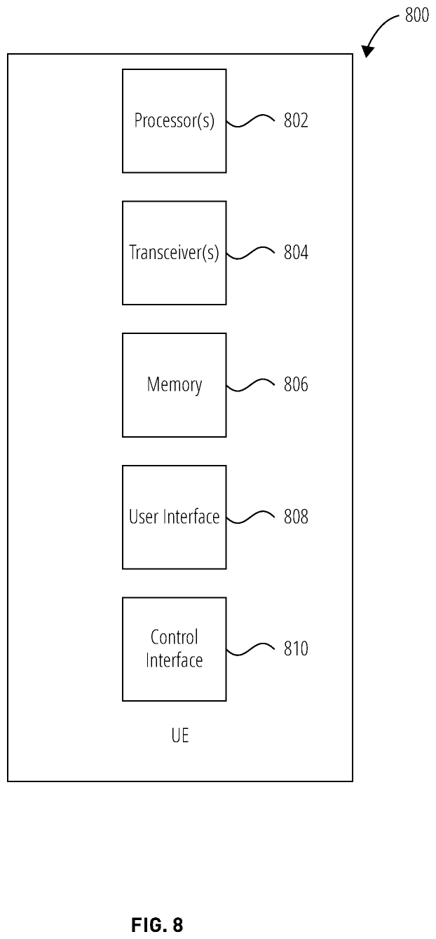

FIG. 8 is a block diagram of an example UE 800 configurable according to various embodiments of the present disclosure, including by execution of instructions on a computer-readable medium that correspond to any of the example methods and/or procedures described herein. The UE 800 comprises one or more processor 802, transceiver 804, memory 806, user interface 808, and control interface 810.

The one or more processor 802 may include, for example, an application processor, an audio digital signal processor, a central processing unit, and/or one or more baseband processors. Each of the one or more processor 802 may include internal memory and/or may include interface(s) to communication with external memory (including the memory 806). The internal or external memory can store software code, programs, and/or instructions for execution by the one or more processor 802 to configure and/or facilitate the UE 800 to perform various operations, including operations described herein. For example, execution of the instructions can configure the UE 800 to communicate using one or more wired or wireless communication protocols, including one or more wireless communication protocols standardized by 3GPP such as those commonly known as 5G/NR, LTE, LTE-A, UMTS, HSPA, GSM, GPRS, EDGE, etc., or any other current or future protocols that can be utilized in conjunction with the one or more transceiver 804, user interface 808, and/or control interface 810. As another example, the one or more processor 802 may execute program code stored in the memory 806 or other memory that corresponds to MAC, RLC, PDCP, and RRC layer protocols standardized by 3GPP (e.g., for NR and/or LTE). As a further example, the processor 802 may execute program code stored in the memory 806 or other memory that, together with the one or more transceiver 804, implements corresponding PHY layer protocols, such as Orthogonal Frequency Division Multiplexing (OFDM), Orthogonal Frequency Division Multiple Access (OFDMA), and Single-Carrier Frequency Division Multiple Access (SC-FDMA).

The memory 806 may comprise memory area for the one or more processor 802 to store variables used in protocols, configuration, control, and other functions of the UE 800, including operations corresponding to, or comprising, any of the example methods and/or procedures described herein. Moreover, the memory 806 may comprise non-volatile memory (e.g., flash memory), volatile memory (e.g., static or dynamic RAM), or a combination thereof. Furthermore, the memory 806 may interface with a memory slot by which removable memory cards in one or more formats (e.g., SD Card, Memory Stick, Compact Flash, etc.) can be inserted and removed.

The one or more transceiver 804 may include radio-frequency transmitter and/or receiver circuitry that facilitates the UE 800 to communicate with other equipment supporting like wireless communication standards and/or protocols. For example, the one or more transceiver 804 may include switches, mixer circuitry, amplifier circuitry, filter circuitry, and synthesizer circuitry. Such RF circuitry may include a receive signal path with circuitry to down-convert RF signals received from a front-end module (FEM) and provide baseband signals to a baseband processor of the one or more processor 802. The RF circuitry may also include a transmit signal path which may include circuitry to up-convert baseband signals provided by a baseband processor and provide RF output signals to the FEM for transmission. The FEM may include a receive signal path that may include circuitry configured to operate on RF signals received from one or more antennas, amplify the received signals and provide the amplified versions of the received signals to the RF circuitry for further processing. The FEM may also include a transmit signal path that may include circuitry configured to amplify signals for transmission provided by the RF circuitry for transmission by one or more antennas. In various embodiments, the amplification through the transmit or receive signal paths may be done solely in the RF circuitry, solely in the FEM, or in both the RF circuitry and the FEM circuitry. In some embodiments, the FEM circuitry may include a TX/RX switch to switch between transmit mode and receive mode operation.

In some exemplary embodiments, the one or more transceiver 804 includes a transmitter and a receiver that enable device 1200 to communicate with various 5G/NR networks according to various protocols and/or methods proposed for standardization by 3 GPP and/or other standards bodies. For example, such functionality can operate cooperatively with the one or more processor 802 to implement a PHY layer based on OFDM, OFDMA, and/or SC-FDMA technologies, such as described herein with respect to other figures.

The user interface 808 may take various forms depending on particular embodiments, or can be absent from the UE 800. In some embodiments, the user interface 808 includes a microphone, a loudspeaker, slidable buttons, depressible buttons, a display, a touchscreen display, a mechanical or virtual keypad, a mechanical or virtual keyboard, and/or any other user-interface features commonly found on mobile phones. In other embodiments, the UE 800 may comprise a tablet computing device including a larger touchscreen display. In such embodiments, one or more of the mechanical features of the user interface 808 may be replaced by comparable or functionally equivalent virtual user interface features (e.g., virtual keypad, virtual buttons, etc.) implemented using the touchscreen display, as familiar to persons of ordinary skill in the art. In other embodiments, the UE 800 may be a digital computing device, such as a laptop computer, desktop computer, workstation, etc. that comprises a mechanical keyboard that can be integrated, detached, or detachable depending on the particular exemplary embodiment. Such a digital computing device can also comprise a touch screen display. Many example embodiments of the UE 800 having a touch screen display are capable of receiving user inputs, such as inputs related to exemplary methods and/or procedures described herein or otherwise known to persons of ordinary skill in the art.

In some exemplary embodiments of the present disclosure, the UE 800 may include an orientation sensor, which can be used in various ways by features and functions of the UE 800. For example, the UE 800 can use outputs of the orientation sensor to determine when a user has changed the physical orientation of the UE 800′s touch screen display. An indication signal from the orientation sensor can be available to any application program executing on the UE 800, such that an application program can change the orientation of a screen display (e.g., from portrait to landscape) automatically when the indication signal indicates an approximate 90-degree change in physical orientation of the device. In this manner, the application program can maintain the screen display in a manner that is readable by the user, regardless of the physical orientation of the device. In addition, the output of the orientation sensor can be used in conjunction with various exemplary embodiments of the present disclosure.

The control interface 810 may take various forms depending on particular embodiments. For example, the control interface 810 may include an RS-232 interface, an RS-485 interface, a USB interface, an HDMI interface, a Bluetooth interface, an IEEE (“Firewire”) interface, an I²C interface, a PCMCIA interface, or the like. In some exemplary embodiments of the present disclosure, control interface 1260 can comprise an IEEE 802.3 Ethernet interface such as described above. In some embodiments of the present disclosure, the control interface 810 may include analog interface circuitry including, for example, one or more digital-to-analog (D/A) and/or analog-to-digital (A/D) converters.

Persons of ordinary skill in the art can recognize the above list of features, interfaces, and radio-frequency communication standards is merely exemplary, and not limiting to the scope of the present disclosure. In other words, the UE 800 may include more functionality than is shown in FIG. 8 including, for example, a video and/or still-image camera, microphone, media player and/or recorder, etc. Moreover, the one or more transceiver 804 may include circuitry for communication using additional radio-frequency communication standards including Bluetooth, GPS, and/or others. Moreover, the one or more processor 802 may execute software code stored in the memory 806 to control such additional functionality. For example, directional velocity and/or position estimates output from a GPS receiver can be available to any application program executing on the UE 800, including various exemplary methods and/or computer-readable media according to various exemplary embodiments of the present disclosure.

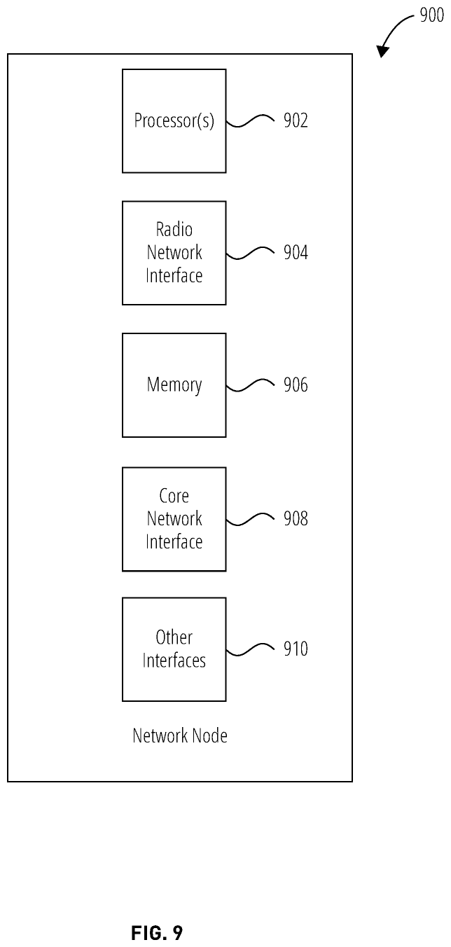

FIG. 9 is a block diagram of an example network node 900 configurable according to various embodiments of the present disclosure, including by execution of instructions on a computer-readable medium that correspond to any of the example methods and/or procedures described herein.

The network node 900 includes a one or more processor 902, a radio network interface 904, a memory 906, a core network interface 908, and other interfaces 910. The network node 900 may comprise, for example, a base station, eNB, gNB, access node, or component thereof.

The one or more processor 902 may include any type of processor or processing circuitry and may be configured to perform an of the methods or procedures disclosed herein. The memory 906 may store software code, programs, and/or instructions executed by the one or more processor 902 to configure the network node 900 to perform various operations, including operations described herein. For example, execution of such stored instructions can configure the network node 900 to communicate with one or more other devices using protocols according to various embodiments of the present disclosure, including one or more methods and/or procedures discussed above. Furthermore, execution of such stored instructions can also configure and/or facilitate the network node 900 to communicate with one or more other devices using other protocols or protocol layers, such as one or more of the PHY, MAC, RLC, PDCP, and RRC layer protocols standardized by 3GPP for LTE, LTE-A, and/or NR, or any other higher-layer protocols utilized in conjunction with the radio network interface 904 and the core network interface 908. By way of example and without limitation, the core network interface 908 comprise an Si interface and the radio network interface 904 may comprise a Uu interface, as standardized by 3GPP. The memory 906 may also store variables used in protocols, configuration, control, and other functions of the network node 900. As such, the memory 906 may comprise non-volatile memory (e.g., flash memory, hard disk, etc.), volatile memory (e.g., static or dynamic RAM), network-based (e.g., “cloud”) storage, or a combination thereof.

The radio network interface 904 may include transmitters, receivers, signal processors, ASICs, antennas, beamforming units, and other circuitry that enables network node 900 to communicate with other equipment such as, in some embodiments, a plurality of compatible user equipment (UE). In some embodiments, the network node 900 may include various protocols or protocol layers, such as the PHY, MAC, RLC, PDCP, and RRC layer protocols standardized by 3GPP for LTE, LTE-A, and/or 5G/NR. According to further embodiments of the present disclosure, the radio network interface 904 may include a PHY layer based on OFDM, OFDMA, and/or SC-FDMA technologies. In some embodiments, the functionality of such a PHY layer can be provided cooperatively by the radio network interface 904 and the one or more processor 902.

The core network interface 908 may include transmitters, receivers, and other circuitry that enables the network node 900 to communicate with other equipment in a core network such as, in some embodiments, circuit-switched (CS) and/or packet-switched Core (PS) networks. In some embodiments, the core network interface 908 may include the S1 interface standardized by 3GPP. In some embodiments, the core network interface 908 may include one or more interfaces to one or more SGWs, MMEs, SGSNs, GGSNs, and other physical devices that comprise functionality found in GERAN, UTRAN, E-UTRAN, and CDMA2000 core networks that are known to persons of ordinary skill in the art. In some embodiments, these one or more interfaces may be multiplexed together on a single physical interface. In some embodiments, lower layers of the core network interface 908 may include one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art.

The other interfaces 910 may include transmitters, receivers, and other circuitry that enables the network node 900 to communicate with external networks, computers, databases, and the like for purposes of operations, administration, and maintenance of the network node 900 or other network equipment operably connected thereto.

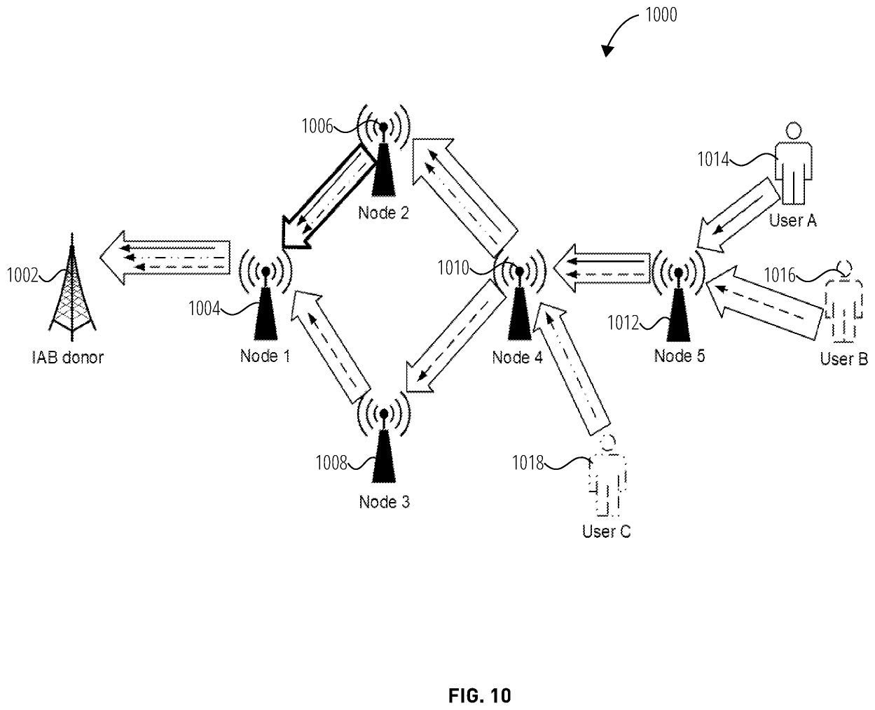

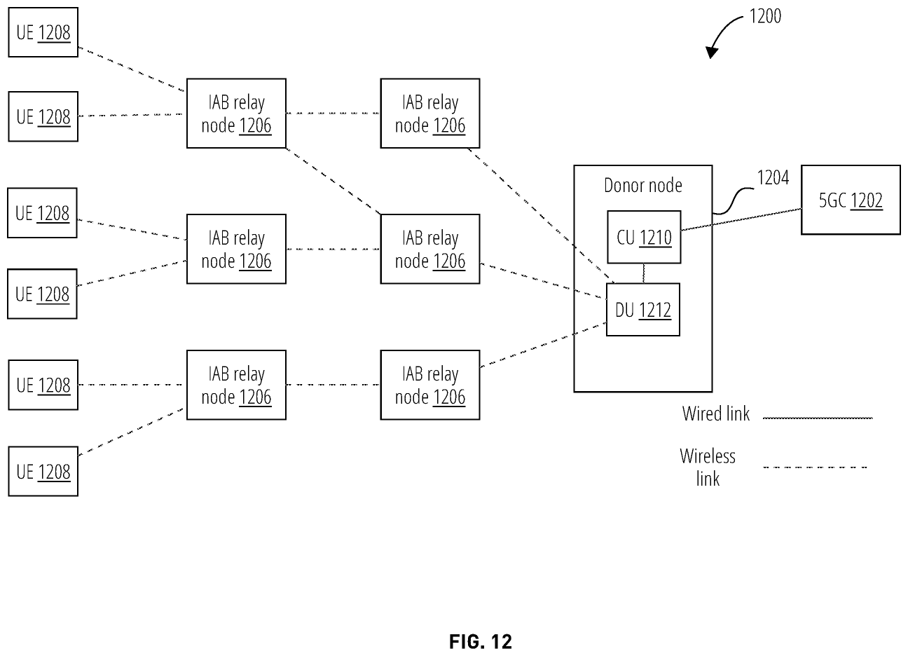

FIG. 10 schematically illustrates an example IAB network 1000 including an IAB donor 1002 and five IAB nodes comprising a first node 1004 (Node 1), a second node 1006 (Node 2), a third node 1008 (Node 3), a fourth node 1010 (Node 4), and a fifth node 1012 (Node 5). As used herein, the IAB nodes may also be referred to as relay nodes. A relay node may receive uplink traffic (represented by arrows) from a descendant or child relay node (or from a UE) and provide the uplink traffic to a parent relay node. Uplink traffic from UEs associated with three users (User A 1014, User B 1016, and User C 1018) are routed through the example IAB network 1000. User A and User B are attached to the fifth node 1012, and User C is attached to the fourth node 1010. User A's uplink traffic is routed through the fourth node 1010, second node 1006, and first node 1004. User B's uplink traffic is routed through the fourth node 1010, third node 1008, and first node 1004. User C's uplink traffic is routed through the second node 1006 and first node 1004. Although the arrows shown in FIG. 10 represent uplink traffic, persons skilled in the art will recognize from the disclosure herein that the IAB nodes may also be used for downlink traffic. See, for example, FIG. 12 for a description of an example IAB architecture 1200.

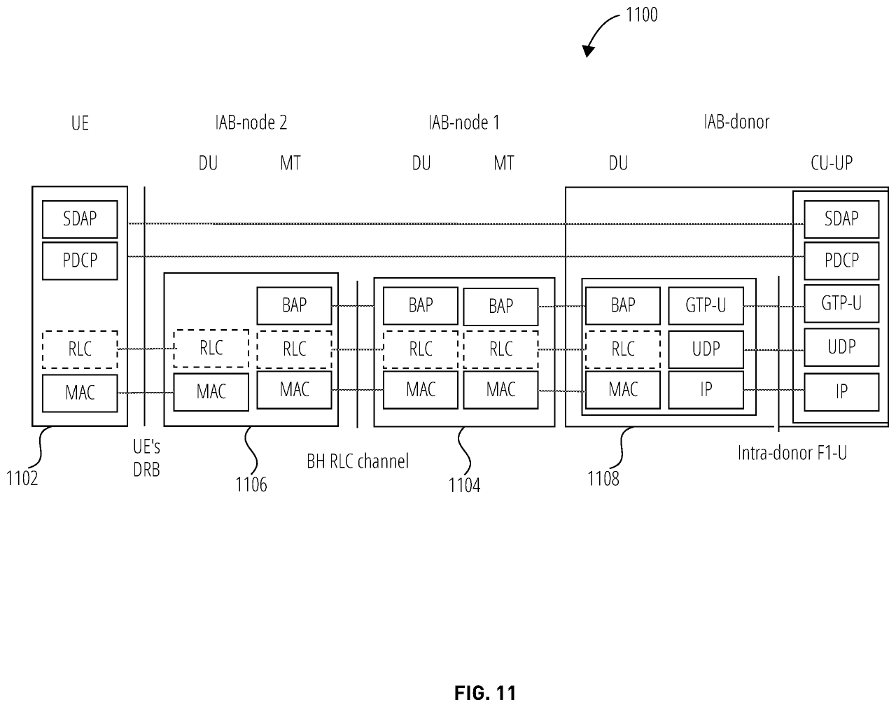

FIG. 11 illustrates an example protocol architecture for IAB 1100 according to one embodiment. The example protocol architecture for IAB 1100 shows various protocol layers for a UE 1102, a first IAB-node 1104 (IAB-node 1), a second IAB-node 1106 (IAB-node 2), and an IAB-donor 1108. The various layers may correspond to mobile terminated (MT), distributed unit (DU), or centralized unit (CU)-user plane (UP) entities. The DU and CU-UP of the IAB-donor 1108 may communicate through an intra-donor Fl-U interface. In this example, the UE 1102 wireless communicates with the second IAB-node 1106 through the UE's dedicated radio bearer (DRB), and the second IAB-node 1106 wirelessly relays the uplink traffic to the first IAB-node 1104 through a backhaul (BH) radio link control (RLC) channel. The protocol layers include, for example, medium access control (MAC), RLC, packet data convergence protocol (PDCP), service data adaptation protocol (SDAP), internet protocol (IP), user datagram protocol (UDP), and general packet radio service (GPRS) tunneling protocol user plane (GTP-U).

The example protocol architecture for IAB 1100 also includes a backhaul adaptation protocol (BAP) layer that provides functionality for routing data for different UE bearers over different routes through the network. This may be done by having an adaptation layer header that includes some information to identify a bearer. The routing includes mapping incoming data to an outgoing link based on the bearer identifier.

Given that different UE bearers can be carried on different routes through the network, in certain embodiments, the buffer occupancy status generated by a node is relevant only to bearers that are routed through that node and the IAB nodes on those routes.

FIG. 12 illustrates an example IAB architecture 1200 according to one embodiment. The example IAB architecture 1200 comprises a 5GC 1202, a donor node 1204, a plurality of IAB nodes (six IAB nodes shown as IAB relay node 1206), and a plurality of UEs (six UEs shown as UE 1208). The donor node 1204 may include a centralized unit (CU, shown as CU 1210) and a distributed unit (DU, shown as DU 1212). The CU 1210 may be split, for example, into a control plane CU and user plane CU. Further, although only one is shown, the DU 1212 may comprise a plurality of distributed units. As shown, solid lines between the CU 1210 and the 5GC 1202 and the DU 1212 may represent wired links (e.g., fiber optic links), whereas dashed lines may represent wireless links.

Each IAB relay node 1206 (also referred to herein as IAB RN or as a “relay Transmission/Reception Point” or “rTRP”) is a network node in an IAB deployment having UE and (at least part of) gNB functions. As shown, some IAB RNs access other IAB RNs, and some IAB RNs access the donor node 1204. An IAB DN (or IAB donor, also referred to as an “anchor node” or the like) is a network node in an IAB deployment that terminates NG interfaces via wired connection(s). The IAB DN is a RAN node that provides a UE's interface to a core network (shown as 5GC 1202) and wireless backhauling functionality to IAB nodes. An IAB node is a relay node and/or a RAN node that supports wireless access to UEs and wirelessly backhaul access traffic.

In embodiments, the IAB system architecture supports multi-hoping backhauling. IAB multi-hop backhauling provides more range extension than single hopping systems. Multi-hop backhauling further enables backhauling around obstacles (e.g., buildings in urban environment for in-clutter deployments). The maximum number of hops in a deployment is expected to depend on many factors such as frequency, cell density, propagation environment, traffic load, various Key Performance Indicators (KPIs), and/or other like factors. From the architecture perspective, flexibility in hop count is desirable, and therefore, the IAB system may not impose limits on the number of backhaul hops.

The IAB system architecture also supports topology adaptation. Topology adaptation refers to procedures that autonomously reconfigure the backhaul network under circumstances, such as blockage or local congestion without discontinuing services for UEs and/or to mitigate service disruption for UEs. For example, wireless backhaul links may be vulnerable to blockage due to moving objects such as vehicles, weather-related events (e.g., seasonal changes (foliage)), infrastructure changes (e.g., new buildings), and/or the like. These vulnerabilities may apply to physically stationary IAB-nodes and/or mobile IAB-nodes. Also, traffic variations can create uneven load distribution on wireless backhaul links leading to local link or node congestion.

In embodiments where multi-hop and topology adaptation are supported, the IAB nodes include topology management mechanisms and route selection and optimization (RSO) mechanisms. Topology management mechanisms include protocol stacks, interfaces between rTRPs or IAB nodes, control and user plane procedures for identifying one or more hops in the IAB network, forwarding traffic via one or multiple wireless backhaul links in the IAB network, handling of QoS, and the like. The RSO mechanisms include mechanisms for discovery and management of backhaul links for TRPs with integrated backhaul and access functionalities; RAN-based mechanisms to support dynamic route selection (potentially without core network involvement) to accommodate short-term blocking and transmission of latency-sensitive traffic across backhaul links; and mechanisms for evaluating different resource allocations/routes across multiple nodes for end-to-end RSO.

The operation of the different links may be on the same frequencies (“in-band”) or different frequencies (“out-of-band”). In-band backhauling includes scenarios where access and backhaul links at least partially overlap in frequency creating half-duplexing or interference constraints, which may imply that an IAB node may not transmit and receive simultaneously on both links. By contrast, out-of-band scenarios may not have such constraints. In embodiments, one or more of the IAB nodes include mechanisms for dynamically allocating resources between backhaul and access links, which include mechanisms to efficiently multiplex access and backhaul links (for both DL and UL directions) in time, frequency, or space under a per-link half-duplex constraint across one or multiple backhaul link hops for both TDD and FDD operation; and cross-link interference (CLI) measurement, coordination and mitigation between rTRPs and UEs.

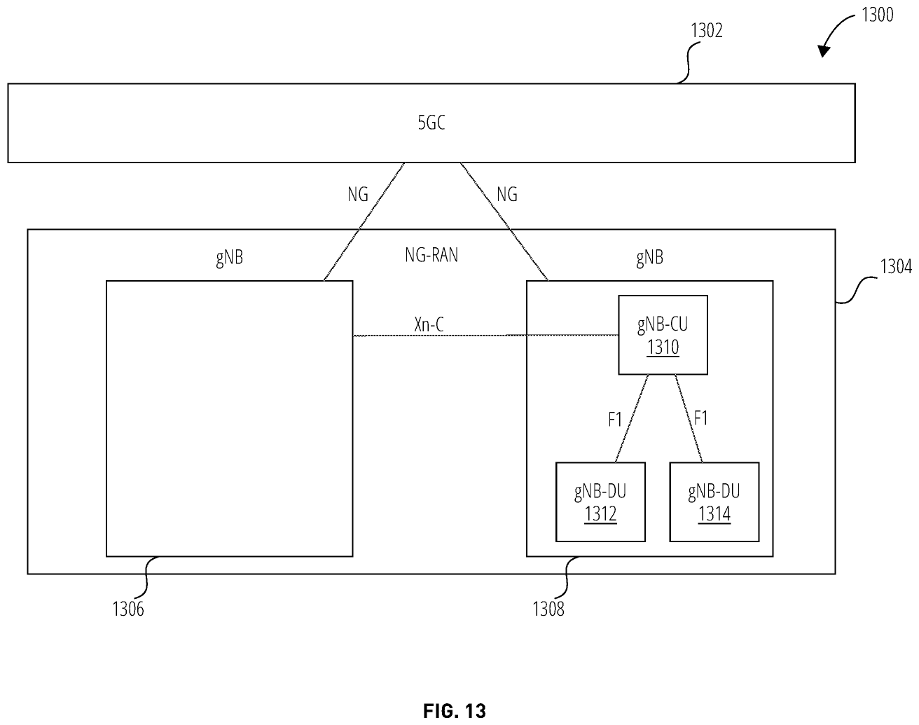

FIG. 13 illustrates an NG-RAN architecture 1300, according to one embodiment, comprising a 5GC 1302 and an NG-RAN 1304. The NG-RAN 1304 includes a plurality of gNB (two gNB shown as gNB 1306 and gNB 1308) connected to the 5GC 1302 through the NG interface. The gNB 1306 and gNB 1308 can support FDD mode, TDD mode, or dual mode operation, and are connected to one another through the Xn-C interface. As shown, the gNB 1308 includes a gNB-CU 1310 connected to a gNB-DU 1312 and a gNB-DU 1314 through the Fl interface. The gNB 1308 may include only a single gNB-DU or more than the two gNB-DUs shown. The NG interface, Xn-C interface, and Fl interface are logical interfaces.

For one or more embodiments, at least one of the components set forth in one or more of the preceding figures may be configured to perform one or more operations, techniques, processes, and/or methods as set forth in the Example Section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Example Section

The following examples pertain to further embodiments.

Example 1 is a method for an Integrated Access and Backhaul (IAB) node to select a parent cell in a wireless network. The method includes: processing system information including a first set of cell selection criteria corresponding to non-IAB user equipments (UEs) and a second set of cell selection criteria corresponding to IAB mobile termination (MT) UEs; measuring a cell to obtain a cell measurement result; determining whether a cell selection condition is satisfied based on the cell measurement result and the second set of cell selection criteria corresponding to IAB MT UEs; and based at least in part on determining that the cell selection condition is satisfied, selecting the cell for wireless backhaul communication.

Example 2 includes the method of Example 1, wherein determining whether the cell section condition is satisfied comprises: calculating a value Srxlev based on a measured cell receive (RX) level value from the cell measurement result; and calculating a value Squal based on a measured cell quality value from the cell measurement result; wherein the cell selection condition is satisfied when the value Srxlev and the value Squal exceed 0, wherein the value Srxlev.

Example 3 includes the method of Example 2, wherein the value Srxlev is determined at least in part as Qrxlevmeas−(Qrxlevmin_iab_Node+Qrxlevminoffset_iab_Node), where: Qrxlevmeas comprises the measured cell RX level value; Qrxlevmin_iab_Node comprises a threshold value from the second set of cell selection criteria for the IAB node indicating a minimum RX level in the cell; and Qrxlevminoffset_iab_Node comprises an offset value from the second set of cell selection criteria for the IAB node indicating an offset to Qrxlevmin_iab_Node.

Example 4 includes the method of Example 3, wherein the value Srxlev further depends on a parameter PMax_iab_Node from the second set of cell selection criteria for the IAB node associated with a maximum transmit (TX) power of the IAB node.

Example 5 includes the method of Example 3, wherein the measured cell RX level value comprises a reference signal received power (RSRP).

Example 6 includes the method of Example 2, wherein the value Squal is determined at least in part as Qqualmeas−(Qqualmin_iab_Node+Qqualminoffset_iab_Node), where: Qqualmeas comprises the measured cell quality value from the cell measurement result; Qqualmin_iab_Node comprises a threshold value from the second set of cell selection criteria for the IAB node indicating a minimum quality level in the cell; and Qqualminoffset iab Node) comprises an offset value from the second set of cell selection criteria for the IAB node indicating an offset to Qqualmin_iab_Node.

Example 7 includes the method of Example 6, wherein the measured cell quality value comprises a reference signal received quality (RSRQ).

Example 8 includes the method of Example 1, further comprising: processing, at the IAB node, a first message from a second IAB node, the first message comprising an indication of a number of hops from the second IAB node to an IAB donor node; and using the indication of the number of hops in a decision for selecting the cell corresponding to the second IAB node for wireless backhaul communication.

Example 9 includes the method of Example 8, further comprising, after connecting to the second IAB, broadcasting a second message from the IAB node to indicate a new number of hops from the IAB node through the second IAB node to the IAB donor node.

Example 10 includes the method of Example 1, further comprising selecting the cell for measurement to obtain the cell measurement result based on an IAB donor node priority metric.

Example 11 includes the method of Example 1, further comprising selecting the cell for wireless backhaul communication over a second cell based at least in part on an IAB donor node priority metric.

Example 12 includes the method of Example 10 or Example 11, wherein the IAB donor node is broadcast or overwritten an individual priority using dedicated signaling.

Example 13 includes the method of Example 1, wherein the IAB node is configured to enter an RRC Connected Inactive state rather than to enter an RRC Idle state.

Example 14 is an apparatus for a first Integrated Access and Backhaul (IAB) node in a wireless network. The apparatus includes a processor, and a memory storing instructions that, when executed by the processor, configure the apparatus to: process, at the first IAB node, a first message from a second IAB node, the first message comprising an indication of a number of hops from the second IAB node to an IAB donor node; and use the indication of the number of hops in a decision for attaching to a cell corresponding to the second IAB node.

Example 15 includes the apparatus of Example 14, wherein the instructions further configure the apparatus to, after connecting to the second IAB, broadcast a second message from the first IAB node to indicate a new number of hops from the first IAB node through the second IAB node to the IAB donor node.

Example 16 is a method comprising: determining an Integrated Access and Backhaul (IAB) donor node metric; and using the IAB donor node metric to identify and prioritize selection or reselection of a particular IAB donor node among a plurality of IAB donor nodes.

Example 17 includes the method of Example 16, wherein the IAB donor node metric is broadcast from the plurality of IAB donor nodes.

Example 18 includes the method of Example 17, wherein the IAB donor node metric is broadcast in an information element (IE) of a system information block (SIB) message.

Example 19 includes the method of Example 17, wherein the IAB donor node metric is based on current loads of the plurality of IAB donor nodes.

Example 20 includes the method of Example 16, wherein determining the IAB donor node metric comprises receiving the IAB donor node metric in a dedicated signaling message.

Example 21 is a computer-readable storage medium, the computer-readable storage medium including instructions that when executed by a computer in a wireless network comprising a plurality of Integrated Access and Backhaul (IAB) nodes, cause the computer to: establish connections between the plurality of IAB nodes in a tree comprising parent nodes and child nodes in radio resource control (RRC) connected mode; and upon individually exiting the RRC connected mode, respectively maintain the plurality of IAB nodes in an RRC connected inactive state rather than an RRC idle state.

Example 22 may include an apparatus comprising means to perform one or more elements of a method described in or related to any of the above Examples, or any other method or process described herein.

Example 23 may include one or more non-transitory computer-readable media comprising instructions to cause an electronic device, upon execution of the instructions by one or more processors of the electronic device, to perform one or more elements of a method described in or related to any of the above Examples, or any other method or process described herein.

Example 24 may include an apparatus comprising logic, modules, or circuitry to perform one or more elements of a method described in or related to any of the above Examples, or any other method or process described herein.

Example 25 may include a method, technique, or process as described in or related to any of the above Examples, or portions or parts thereof.

Example 26 may include an apparatus comprising: one or more processors and one or more computer-readable media comprising instructions that, when executed by the one or more processors, cause the one or more processors to perform the method, techniques, or process as described in or related to any of the above Examples, or portions thereof.

Example 27 may include a signal as described in or related to any of the above Examples, or portions or parts thereof.

Example 28 may include a datagram, packet, frame, segment, protocol data unit (PDU), or message as described in or related to any of the above Examples, or portions or parts thereof, or otherwise described in the present disclosure.

Example 29 may include a signal encoded with data as described in or related to any of the above Examples, or portions or parts thereof, or otherwise described in the present disclosure.

Example 30 may include a signal encoded with a datagram, packet, frame, segment, PDU, or message as described in or related to any of the above Examples, or portions or parts thereof, or otherwise described in the present disclosure.

Example 31 may include an electromagnetic signal carrying computer-readable instructions, wherein execution of the computer-readable instructions by one or more processors is to cause the one or more processors to perform the method, techniques, or process as described in or related to any of the above Examples, or portions thereof.

Example 32 may include a computer program comprising instructions, wherein execution of the program by a processing element is to cause the processing element to carry out the method, techniques, or process as described in or related to any of the above Examples, or portions thereof.

Example 33 may include a signal in a wireless network as shown and described herein.

Example 34 may include a method of communicating in a wireless network as shown and described herein.

Example 35 may include a system for providing wireless communication as shown and described herein.

Example 36 may include a device for providing wireless communication as shown and described herein.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for an Integrated Access and Backhaul (IAB) node to select a parent cell in a wireless network, the method comprising:
processing system information including a first set of cell selection criteria corresponding to non-IAB user equipments (UEs) and a second set of cell selection criteria corresponding to IAB mobile termination (MT) UEs;
measuring a cell to obtain a cell measurement result;
determining whether a cell selection condition is satisfied based on the cell measurement result and the second set of cell selection criteria corresponding to IAB MT UEs; and
based at least in part on determining that the cell selection condition is satisfied, selecting the cell for wireless backhaul communication.

2. The method of claim 1, wherein determining whether the cell selection condition is satisfied comprises:
calculating a value Srxlev based on a measured cell receive (RX) level value from the cell measurement result; and
calculating a value Squal based on a measured cell quality value from the cell measurement result;
wherein the cell selection condition is satisfied when the value Srxlev and the value Squal exceed 0, wherein the value Srxlev.

3. The method of claim 2, wherein the value Srxlev is determined at least in part as Qrxlevmeas−(Qrxlevmin_iab_Node+Qrxlevminoffset_iab_Node), where:
Qrxlevmeas comprises the measured cell RX level value;
Qrxlevmin_iab_Node comprises a threshold value from the second set of cell selection criteria for the IAB node indicating a minimum RX level in the cell; and
Qrxlevminoffset_iab_Node comprises an offset value from the second set of cell selection criteria for the IAB node indicating an offset to Qrxlevmin_iab_Node.

4. The method of claim 3, wherein the value Srxlev further depends on a parameter PMax_iab_Node from the second set of cell selection criteria for the IAB node associated with a maximum transmit (TX) power of the IAB node.

5. The method of claim 3, wherein the measured cell RX level value comprises a reference signal received power (RSRP).

6. The method of claim 2, wherein the value Squal is determined at least in part as Qqualmeas−(Qqualmin_iab_Node+Qqualminoffset_iab_Node), where:
Qqualmeas comprises the measured cell quality value from the cell measurement result;
Qqualmin_iab_Node comprises a threshold value from the second set of cell selection criteria for the IAB node indicating a minimum quality level in the cell; and
Qqualminoffset_iab_Node) comprises an offset value from the second set of cell selection criteria for the IAB node indicating an offset to Qqualmin_iab_Node.

7. The method of claim 6, wherein the measured cell quality value comprises a reference signal received quality (RSRQ).

8. The method of claim 1, further comprising:
processing, at the IAB node, a first message from a second IAB node, the first message comprising an indication of a number of hops from the second IAB node to an IAB donor node; and
using the indication of the number of hops in a decision for selecting the cell corresponding to the second IAB node for wireless backhaul communication.

9. The method of claim 8, further comprising, after connecting to the second IAB, broadcasting a second message from the IAB node to indicate a new number of hops from the IAB node through the second IAB node to the IAB donor node.

10. The method of claim 1, further comprising selecting the cell for measurement to obtain the cell measurement result based on an IAB donor node priority metric.

11. The method of claim 1, further comprising selecting the cell for wireless backhaul communication over a second cell based at least in part on an IAB donor node priority metric.

12. The method of claim 10, wherein the IAB donor node is broadcast or overwritten an individual priority using dedicated signaling.

13. The method of claim 1, wherein the IAB node is configured to enter an RRC Connected Inactive state rather than to enter an RRC Idle state.

14. An apparatus for a first Integrated Access and Backhaul (IAB) node in a wireless network, the apparatus comprising:
a processor; and
a memory storing instructions that, when executed by the processor, configure the apparatus to:
process, at the first IAB node, a first message from a second IAB node, the first message comprising an indication of a number of hops from the second IAB node to an IAB donor node; and
use the indication of the number of hops in a decision for attaching to a cell corresponding to the second IAB node.

15. The apparatus of claim 14, wherein the instructions further configure the apparatus to, after connecting to the second IAB, broadcast a second message from the first IAB node to indicate a new number of hops from the first IAB node through the second IAB node to the IAB donor node.

16. A method comprising:
determining an Integrated Access and Backhaul (IAB) donor node metric; and
using the IAB donor node metric to identify and prioritize selection or reselection of a particular IAB donor node among a plurality of IAB donor nodes.

17. The method of claim 16, wherein the IAB donor node metric is broadcast from the plurality of IAB donor nodes.

18. The method of claim 17, wherein the IAB donor node metric is broadcast in an information element (IE) of a system information block (SIB) message.

19. The method of claim 17, wherein the IAB donor node metric is based on current loads of the plurality of IAB donor nodes.

20. The method of claim 16, wherein determining the IAB donor node metric comprises receiving the IAB donor node metric in a dedicated signaling message.

21. (canceled)
